(19) United States
(12) Patent Application Publication
(10) Pub. No.: US 2008/0180895 A1
(43) Pub. Date: Jul. 31, 2008

(54) PORTABLE TERMINAL

(76) Inventors: Jae-Chul JIN, Suwon-si (KR); Ki-Taek Kim, Yongin-si (KR); Jin-Soo Kim, Suwon-si (KR); Young-Ki Kim, Yongin-si (KR)

Correspondence Address: THE FARRELL LAW FIRM, P.C., 333 EARLE OVINGTON BOULEVARD, SUITE 701, UNIONDALE, NY, 11553, US

(21) Appl. No.: 12/020,194

(22) Filed: Jan. 25, 2008

(30) Foreign Application Priority Data
Jan. 29, 2007 (KR) 207-8853

(51) Int. Cl. G06F 1/16

(52) U.S. Cl. 361/681

(57) ABSTRACT

A portable terminal is disclosed that includes a first housing, having a lowered surface portion and a second housing seated on the lowered surface portion of the first housing to be rotated while facing the first housing. When the second housing is placed at a first position in which it is placed in a lengthwise direction of the first housing and second and third positions in which it is rotated from the first position by 90° clockwise and counterclockwise and is placed in a direction perpendicular to the lengthwise direction of the first housing, any one of sidewalls of the second housing is held close to a vertical wall of the first housing, defined between the lowered surface portion and a raised surface portion of the first housing.

### PRIORITY

This application claims priority under 35 U.S.C. §119(a) to an application entitled “Portable Terminal” filed in the Korean Industrial Property Office on Jan. 29, 2007 and assigned Serial No. 2007-0008853, the contents of which are incorporated herein by reference.

### BACKGROUND OF THE INVENTION

1. Field of the Invention

The present invention relates to a portable terminal, and, more particularly, to a swing-type portable terminal in which a pair of housings are rotatably coupled to each other while facing each other.

2. Description of the Related Art

As generally known in the art, conventional portable terminals are divided into a bar type, a flip type and a folder type, depending upon shapes and folding thereof.

In the bar type portable terminal, a microphone, a speaker, a keypad and a display are provided on a single housing. In the bar type portable terminal, since the keypad, which is a data input means, is always exposed to the outside, unwanted operation of the portable terminal can occur, and, since it is difficult to secure a sufficient distance between the microphone and the speaker, limitations exist in miniaturizing the portable terminal.

The flip type portable terminal includes a terminal body, a flip and a hinge module for connecting the terminal body and the flip to each other. A microphone, a speaker, a keypad, and a display are provided on the terminal body. In the flip type portable terminal, since the keypad is covered by the flip, unwanted operation of the portable terminal can be avoided. However, because it is difficult to secure a sufficient distance between the microphone and the speaker, limitations still exist in miniaturizing the portable terminal.

The folder type portable terminal includes a terminal body, a folder and a hinge module for connecting the terminal body and the folder to each other. The folder type portable terminal is opened and closed as the folder is rotated about the hinge module. Under a communication standby mode, the folder is closed to cover the terminal body and to prevent unwanted manipulation of the keypad. In a communication mode, since the folder is opened and can secure a sufficient distance between a microphone and a speaker, advantages are provided in miniaturizing the portable terminal.

While the mobile communication services using portable terminals had initially been limited to voice communication and transmission of a short message, these days, they are developed from entertainment services including games, animations and sounds of bells to multimedia services including motion pictures, video on demand and audio on demand. Recently, a Digital Multimedia Broadcasting (DMB) service through a portable terminal has been started.

However, in order to watch moving pictures or enjoy broadcasting services through conventional portable terminals, it is necessary to place the portable terminals in a horizontal orientation. Also, since the conventional portable terminals have been designed to be suitable for the use of a mobile communication service when the portable terminals are placed in a transverse direction to watch broadcasts, etc., it is not convenient to manipulate the keys on the keypads, etc.

### SUMMARY OF THE INVENTION

Accordingly, the present invention has been made to solve the above-mentioned problems occurring in conventional systems, and the present invention provides a portable terminal which can be conveniently used when watching a moving picture or enjoying a multimedia service.

Also, the present invention provides a portable terminal which can be easily manipulated while enjoying a multimedia service.

In addition, the present invention provides a portable terminal which can be easily changed in a window display direction between a transverse direction and a longitudinal direction.

In accordance with an aspect of the present invention, there is provided a portable terminal comprising a first housing having a lowered surface portion; and a second housing seated on the lowered surface portion of the first housing to be rotated while facing the first housing, wherein, when the second housing is placed at a first position in which it is placed in a lengthwise direction of the first housing and second and third positions in which it is rotated from the first position by 90° clockwise and counterclockwise and is placed in a direction perpendicular to the lengthwise direction of the first housing, any one of sidewalls of the second housing is held close to a vertical wall of the first housing which is defined between the lowered surface portion and a raised surface portion of the first housing.

In accordance with another aspect of the present invention, there is provided a portable terminal comprising a first housing having a lowered surface portion; a second housing seated on the lowered surface portion of the first housing to be rotated while facing the first housing; and a driving member interposed between the first and second housings to provide driving force for rotating the second housing, wherein a vertical wall of the first housing, which is defined between the lowered surface portion and a raised surface portion of the first housing, has a plane surface contour, and, when the second housing is rotated, any one of corners of the second housing linearly moves while being positioned adjacent to the vertical wall of the first housing or being brought into sliding contact therewith.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view illustrating a portable terminal in accordance with a first embodiment of the present invention;

FIG. 2 is an assembled perspective view of the portable terminal shown in FIG. 1;

FIG. 3 is a perspective view illustrating a state in which the second housing of the portable terminal shown in FIG. 2 is rotated;

FIG. 4 is a perspective view illustrating the rear surface of the second housing of the portable terminal shown in FIG. 1;

FIG. 5 is a schematic cross-sectional view illustrating a structure in which the second housing of the portable terminal shown in FIG. 1 is coupled to a first housing;

FIGS. 6 through 8 are plan views sequentially illustrating rotation of the second housing of the portable terminal shown in FIG. 1;

FIG. 9 is an exploded perspective view illustrating a portable terminal in accordance with a second embodiment of the present invention; and

FIG. 10 is a plan view illustrating rotation of the second housing of the portable terminal shown in FIG. 9.

### DETAILED DESCRIPTION OF THE PREFERRED EMBODIMENTS

Hereinafter, exemplary embodiments of the present invention will be described with reference to the accompanying drawings. In the following description of the present invention, a detailed description of known functions and configurations incorporated herein will be omitted when it may make the subject matter of the present invention rather unclear. A portable terminal according to the present invention includes a first housing and a second housing which is rotatably coupled to the first housing. The first housing has a lowered front upper surface portion for seating the second housing thereon. When the second housing is rotated with respect to the first housing, one of the corners of the second housing can linearly move while being positioned adjacent to the vertical wall formed between the lowered front upper surface portion and a raised front lower surface portion of the first housing or being brought into sliding contact with the vertical wall. The vertical wall has a plane surface contour.

Accordingly, in a state in which the second housing is placed in the lengthwise direction of the first housing or is rotated either 90° clockwise or counterclockwise with respect to the first housing, one of the side surfaces of the second housing is kept in close proximity to the vertical wall of the first housing.

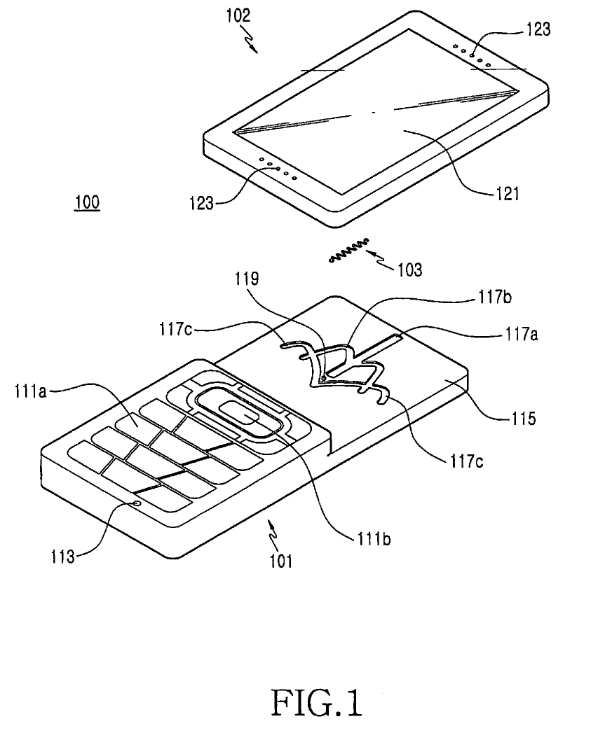

Referring to FIGS. 1 through 3, a portable terminal 100 in accordance with a first embodiment of the present invention includes a first housing 101, a second housing 102 which faces and is rotatably coupled to the first housing 101. In order to couple the second housing 102 to the first housing 101, a lowered surface portion 115 is formed on the front surface of the first housing 101. The first housing 101 has a front surface which is divided by a vertical wall into the lowered surface portion 115 and a raised surface portion. The vertical wall of the first housing 101 has a plane surface contour. When the second housing 102 is rotated, any one of the corners of the second housing 102 linearly move while one corner is being positioned adjacent to the vertical wall of the first housing 101 or being brought into sliding contact with the vertical wall of the first housing 101. In this embodiment of the present invention, an example of one of the corners of the second housing 102 is brought into sliding contact with the vertical wall of the first housing 101 is illustrated and described.

An input keypad 111a and a function keypad 111b are provided on the raised surface portion of the first housing 101. The lowered surface portion 115 corresponds to the front upper surface portion of the first housing 101, and the raised surface portion corresponds to the front lower surface portion of the first housing 101. Therefore, on the front surface of the first housing 101, the lowered surface portion 115 is provided at a lower depth than the raised surface portion. The vertical wall is formed between the raised surface portion and the lowered surface portion 115 of the first housing 101.

A microphone 113 is installed adjacent to the lower end of the first housing 101 to be used for allowing a user to input voice. If the portable terminal 100 has a camera unit, voice can be simultaneously recorded using the microphone 113 when taking a moving picture.

A display 121 and speakers 123 are provided on the second housing 102. The display 121 can display the status information of the portable terminal 100 including a sensitivity of transmission and reception with a base station, a current time and a remaining battery quantity, and communication information including whether a message is received. In accordance with an operation mode of the portable terminal 100, the display 121 can output a moving picture, a broadcast, etc.

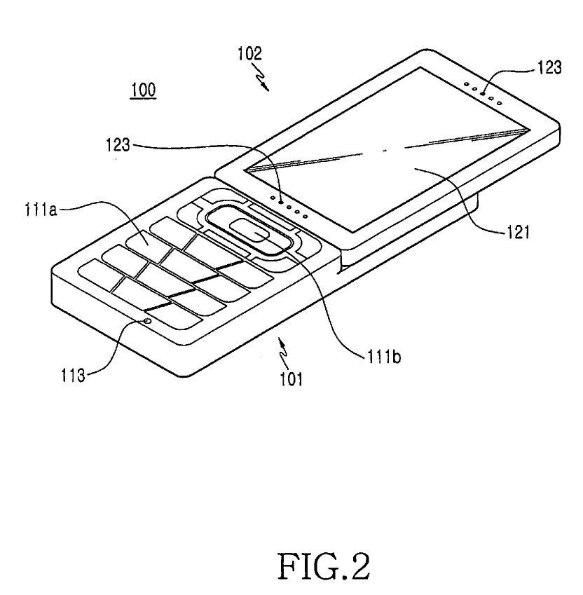

Due to the fact that the second housing 102 is rotatably coupled to the first housing 101 while facing the first housing 101, the display 121 can have a display window which is viewable in wider format, i.e. in the longitudinal or transverse direction. For example, as shown in FIG. 2, when the second housing 102 is placed at a first position in which it is placed in the lengthwise direction of the first housing 101, the display 121 has a wide display window in the longitudinal direction. When the display 121 has a wide display window in the longitudinal direction, the portable terminal 100 can operate under a mobile communication mode to be used for voice communication, text messaging or wireless Internet connection.

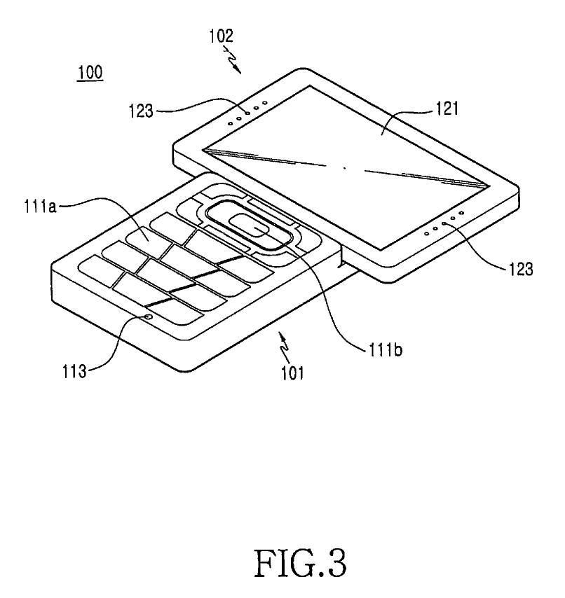

Referring to FIG. 3, when the second housing 102 is placed at second or third position where the second housing 102 is rotated through 90°, either clockwise or counterclockwise, with respect to the first housing 101, the display 121 presents a wider display window in the transverse direction. Therefore, the second housing 102 can be selectively rotated clockwise or counterclockwise from the first position. If the second housing 102 is rotated in any direction, the display 121 has a wide display window in the transverse direction in the state in which it is rotated by 90° from the first position.

Depending upon a direction in which the display 121 is rotated, the window screen on the display 121 is oppositely changed, and a user can use the portable terminal 100 while holding the first housing 101 in the user's hand. Thus, when the display 121 is rotated between the second and third positions, the window screen on the display 121 must be automatically reversed.

In other words, if the display 121 normally displays a window screen with the second housing 102 placed at the second position, the display 121 may display an upturned window screen with the second housing 102 placed at the third position. As a consequence, when the display 121 is rotated between the second and third positions, the window screen on the display 121 is preferably automatically reversed.

In this regard, because the present invention is directed for a portable terminal in which a pair of housings are coupled while facing each other, the detailed description for a construction for controlling the reversal of the window screen will be omitted herein.

The speakers 123 are provided adjacent to upper and lower ends, respectively, of the display 121. At the first position, the speaker 123 placed adjacent to the upper end of the display 121 serves as a reception unit at the upper end of the portable terminal 100. Further, at the second or third position, the speakers 123 are placed on both sides of the portable terminal 100 and output stereo or three dimensional surround sound when enjoying a multimedia service.

In order to rotatably couple the second housing 102 to the first housing 101, the portable terminal 100 has first, second and third guide grooves, 117a, 117b and 117c, respectively, which are provided on the lowered surface portion 115 of the first housing 101, and first, second and third guide projections, 125a, 125b and 125c, respectively, which are formed on the rear surface of the second housing 102.

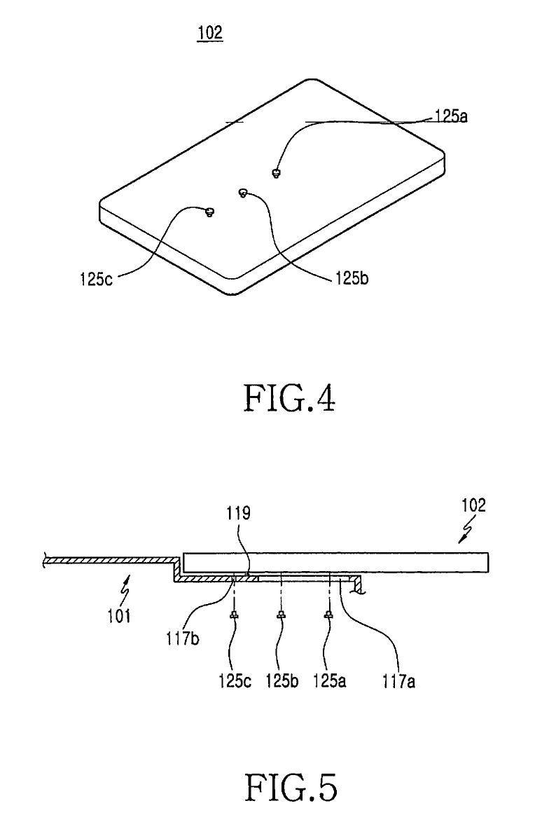

Referring to FIGS. 4 and 5, the first, second and third guide projections 125a, 125b and 125c are formed as pin-shaped members which are coupled to the rear surface of the second housing 102. The first, second and third guide projections 125a, 125b and 125c are supported by the inner surface of the first housing 101, project out of the lowered surface portion 115 through the first, second and third guide grooves 117a, 117b and 117c, respectively, and are coupled to the rear surface of the second housing 102. The first, second and third guide projections 125a, 125b and 125c are arranged in line along the lengthwise direction of the second housing 102.

The first guide projection 125a is arranged at the center portion of the rear surface of the second housing 102, provides the rotation center of the second housing 102, and is linearly movably coupled to the first housing 101. The first guide groove 117a provides a space in which the first guide projection 125a can move, and extends in the lengthwise direction of the first housing 101. When the second housing 102 is rotated, the first guide projection 125a linearly moves in the first guide groove 117a and provides the rotation center of the second housing 102.

The second guide projection 125b is arranged at a position which is spaced apart from the first guide projection 125a. When the second housing 102 is rotated, the second guide projection 125b moves on the lowered surface portion 115 of the first housing 101 along a curved locus. The third guide projection 125c is arranged at a position which is spaced apart from the second guide projection 125b. Similar to the second guide projection 125b, when the second housing 102 is rotated, the third guide projection 125c moves on the lowered surface portion 115 of the first housing 101 along a curved locus which is different from that of the second guide projection 125b.

In order to provide spaces in which the second and third guide projections 125b and 125c can move, the second and third guide grooves 117b and 117c are defined. The second and third guide grooves 117b and 117c are defined along the movement loci of the second and third guide projections 125b and 125c, respectively. The second guide groove 117b extends laterally from both sides of the first guide groove 117a and is symmetrical about the first guide groove 117a. The third guide groove 117c extends from the center portion of the lowered surface portion 115 of the first housing 101 in both sideward directions and is left-to-right symmetrical.

It is to be noted that the second and third guide grooves 117b and 117c can cross with each other. Further, it is contemplated that, depending upon the positions of the second and third guide projections 125b and 125c, the second and third guide grooves 117b and 117c can have different loci and may not cross each other and may be defined independently of each other.

The portable terminal 100 further includes a driving member 103 (FIGS. 1,6-10), which is interposed between the first and second housings 101 and 102 to provide driving force for rotating the second housing 102. When the second housing 102 is rotated between the first and second positions, the driving member 103 provides driving force for rotating the second housing 102 to the first or second position depending upon the rotated position of the second housing 102. Similarly, when the second housing 102 is rotated between the first and third positions, the driving member 103 provides driving force for rotating the second housing 102 to the first or third position depending upon the rotated position of the second housing 102.

The driving member 103 applies compressive elastic force for allowing both ends thereof to be pulled toward each other. One end of the driving member 103 is connected to the first housing 101, and the other end of the driving member 103 is connected to the second housing 102. As the driving member 103, a coil type tension spring or a zigzag type wire spring can be employed. When considering the fact that the driving member 103 is interposed between the first and second housings 101 and 102, it is preferable to use the zigzag type wire spring which has a thickness less than that of the coil type spring.

In order to install the driving member 103, a support projection 119 is formed on the lowered surface portion 115 of the first housing 101 between the first guide groove 117a and the third guide groove 117c. The support projection 119 is arranged in line with the first guide groove 117a in the lengthwise direction of the first housing 101, and projects out of the lowered surface portion 115 to rotatably support one end of the driving member 103. The other end of the driving member 103 is rotatably supported by the second guide projection 125b.

When the second housing 102 is placed at the first, second or third position, both ends of the driving member 103 approach each other, and the driving member 103 still applies compressive elastic force for allowing both ends thereof to be pulled toward each other.

As the second housing 102 is rotated between the first and second positions, a position where both ends of the driving member 103 are farthest from each other exists. As the second housing 102 is rotated between the first and third positions, a position, where both ends of the driving member 103 are farthest from each other also exists.

When the second housing 102 is rotated from the first position toward the position where both ends of the driving member 103 are farthest from each other, both ends of the driving member 103 will gradually move apart from each other. Also, when the second housing 102 is rotated from the second or third position toward the position where both ends of the driving member 103 are farthest from each other, both ends of the driving member 103 will gradually move apart from each other.

Accordingly, depending upon the rotated position of the second housing 102, the driving member 103 provides driving force for rotating the second housing 102 to the first, second or third position.

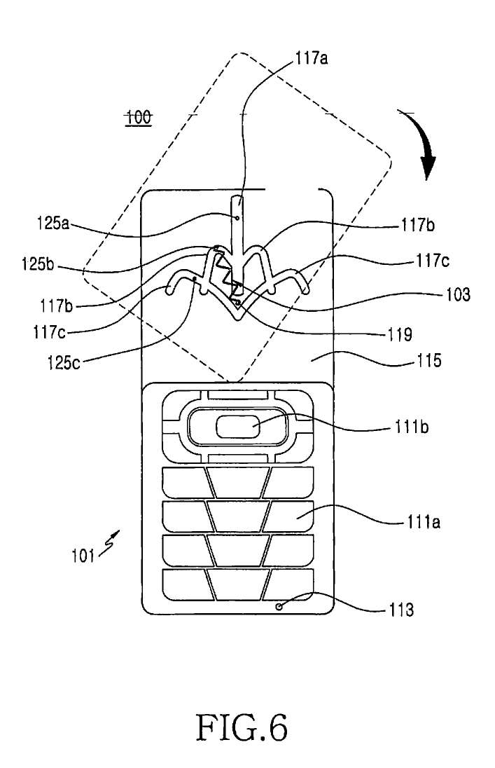

Hereafter, a procedure, in which the second housing 102 is rotated clockwise from the first position to the second position, will be described with reference to FIGS. 6 through 8. From this procedure, one of ordinary skill in the art can readily understand a procedure, in which the second housing 102 is rotated counterclockwise from the first position to the third position. That is to say, the procedure, in which the second housing 102 is rotated counterclockwise from the first position to the third position, is implemented in the same manner as the procedure in which the second housing 102 is rotated clockwise from the first position to the second position, except that the rotating direction of the second housing 102 is changed. Thus, the detailed description of the procedure in which the second housing 102 is rotated counterclockwise from the first position to the third position is omitted herein.

In a state in which the second housing 102 is placed at the first position, that is, located in the lengthwise direction of the first housing 101 as shown in FIG. 2, the second and third guide projections 125b and 125c are placed at the center portions of the second and third guide grooves 117b and 117c, respectively. At this time, since the second guide groove 117b extends laterally from both sides of the first guide groove 117a, the second guide projection 125b is placed at the center portion of the second guide groove 117b.

At this time, a lower one of the sidewalls of the second housing 102 is kept close to the vertical wall of the first housing 101. The elastic force of the driving member 103 is applied in a direction where the second housing 102 is brought into close contact with the lowered surface portion 115. Therefore, the second housing 102 can be stably held in a stopped state.

If a user rotates the second housing 102 clockwise, the first guide projection 125a moves upward along the first guide groove 117a, and the second and third guide projections 125b and 125c move along the second and third guide grooves 117b and 117c, respectively. As both ends of the driving member 103 gradually move apart from each other, the elastic force accumulated in the driving member 103 increases. At this time, the corner of the second housing 102, which is positioned between the lower and right sidewalls, slides on the vertical wall of the first housing 101.

If the first guide projection 125a, the first guide groove 117a, and the corner of the second housing 102, which slides on the vertical wall of the first housing 101, are arranged in line, the driving member 103 accumulates a maximum elastic force. That is to say, while the corner of the second housing 102 slides on the vertical wall of the first housing 101, if it is arranged in line with the first guide projection 125a and the first guide groove 117a, both ends of the driving member 103 are farthest apart from each other.

FIG. 6 illustrates a state in which the second housing 102 is placed between the first position and a position where both ends of the driving member 103 are farthest from each other. In this state, the driving member 103 provides driving force for rotating the second housing 102 to the first position.

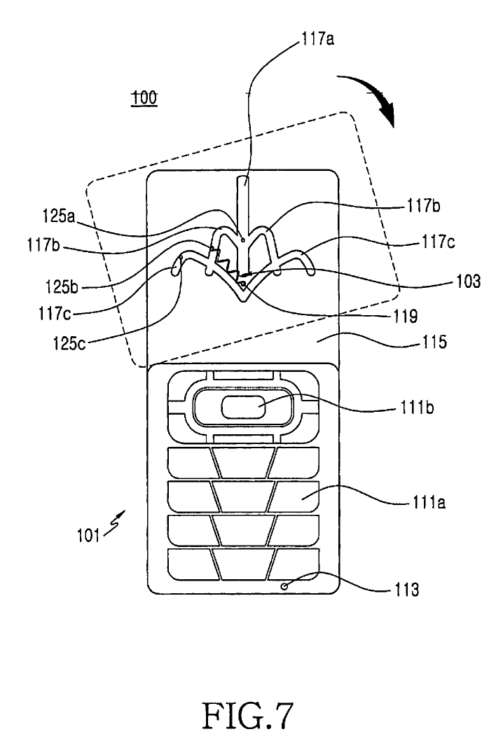

FIG. 7 illustrates a state in which the second housing 102 is placed between the second position and the position where both ends of the driving member 103 are farthest from each other. In this state, the driving member 103 provides driving force for rotating the second housing 102 to the second position. Namely, while the corner of the second housing 102 slides on the vertical wall of the first housing 101, if it passes a position where it is arranged in line with the first guide projection 125a and the first guide groove 117a, the driving force of the driving member 103 changes direction to rotate the second housing 102 to the second position.

Hence, when it is necessary to rotate the second housing 102 from the first position to the second position, as the user manually rotates the second housing 102 from the first position until the second housing 102 passes the position where both ends of the driving member 103 are farthest from each other, the driving force of the driving member 103 rotates the second housing 102 to the second position starting from the position where both ends of the driving member 103 are farthest from each other.

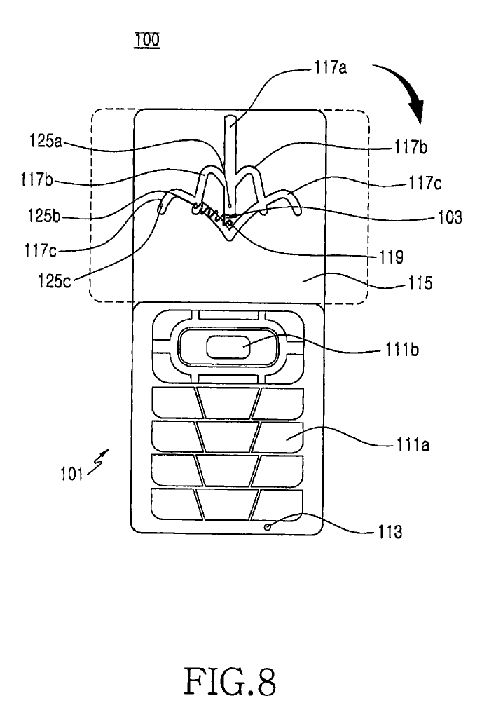

When the second housing 102 is placed at the second position, the second and third guide projections 125b and 125c are respectively placed in the ends of the second and third guide grooves 117b and 117c. At this time, the elasticity of the driving member 103 provides driving force for biasing the second guide projection 125b counterclockwise, as shown in FIG. 8. Moreover, as the first, second and third guide projections 125a, 125b and 125c are placed in the ends of the first, second and third guide grooves 117a, 117b and 117c, respectively, another side wall of the second housing 102 is brought into close contact with the vertical wall of the first housing 101, whereby the stopped state of the second housing 102 can be stably maintained.

If the second housing 102 is placed at the second or third position, the display 121 provides a wide display window in the transverse direction of the first housing 101. Therefore, with the second housing 102 placed at the second or third position, a user can conveniently watch a moving picture or enjoy a multimedia service.

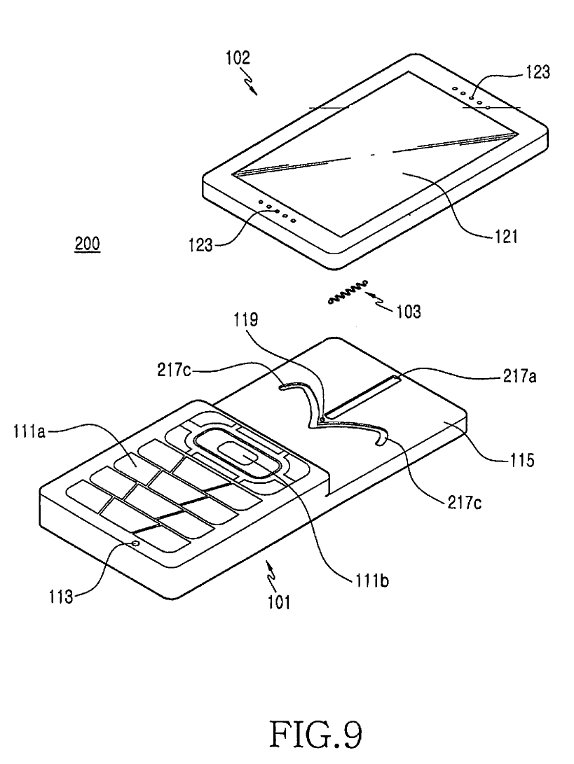

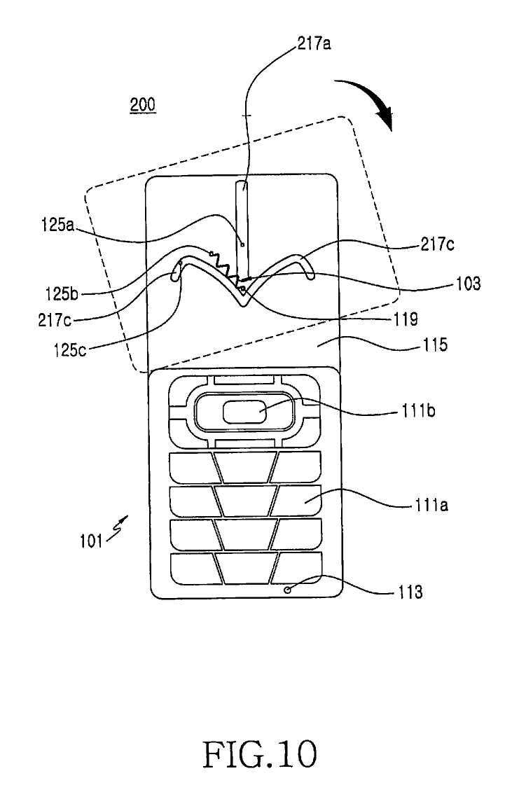

FIGS. 9 and 10 illustrate a portable terminal 200 in accordance with a second embodiment of the present invention. The portable terminal 200 is different from the first embodiment in that the second guide groove is not defined and the second guide projection serves as a second support projection 125b for supporting the other end of the driving member 103. Therefore, in explaining the present embodiment in detail, the same reference numerals will be used to refer to the same or like component elements, and a detailed description thereof need not be repeated here.

In order to couple the second housing 102 to the first housing 101, the first and third guide projections 125a and 125c extend from the inside of the first housing 101, project out of the lowered surface portion 115, and are coupled to the rear surface of the second housing 102.

When the second housing 102 is rotated, the first guide projection 125a linearly moves along the first guide groove 217a which is defined on the lowered surface portion 115 and provides the rotation center of the second housing 102. At this time, the third guide projection 125c moves along the third guide groove 217c, which is also defined on the lowered surface portion 115. As the second housing 102 is rotated, the third guide projection 125c rotates about the first guide projection 125a and moves along the locus of the third guide groove 217c on the lowered surface portion 115 as shown in FIG. 10.

Meanwhile, the driving member 103 has one end which is connected to the support projection 119, which is formed on the first housing 101, and an other end which is connected to the second support projection 125b, and provides compressive elastic force for allowing both ends thereof to be pulled toward each other.

If the second housing 102 is rotated clockwise from the first position in which it is placed in the lengthwise direction of the first housing 101, one of the corners of the second housing 102 linearly moves on the vertical wall of the first housing 101, and the first guide projection 125a moves upward along the first guide groove 217a. The third guide projection 125c moves along the third guide groove 217c.

If the corner of the second housing 102 that slides on the vertical wall of the first housing 101 is arranged in line with the first guide projection 125a and the first guide groove 217a, both ends of the driving member 103 are spaced farthest apart from each other.

If the second housing 102 is rotated past the position where both ends of the driving member 103 are farthest apart from each other, the elastic force of the driving member 103 is changed in its direction to rotate the second housing 102 clockwise and to bring the sidewall of the second housing 102 into close contact with the vertical wall of the first housing 101. As a consequence, the second housing 102 is placed at the second position by being rotated through 90° clockwise from the first position, and one side wall of the second housing 102 is brought into close contact with the vertical wall of the first housing 101.

As apparent from the above description, in the portable terminal according to the present invention, when first and second housings are rotatably coupled to each other while facing each other, since the second housing can be freely rotated clockwise and counterclockwise, the second housing can be easily rotated. Therefore, since conversion between a communication mode and a multimedia mode and change of a window display direction can be easily implemented, convenience can be improved in the use of the portable terminal. Also, while enjoying a multimedia service, because the keypads provided to the first housing can be easily manipulated in the same manner as are under the communication mode, the portable terminal can be more conveniently used.

Further, use of a driving member to provide elastic force for rotating the second housing with respect to the first housing allows for semi-automatic rotation of the second housing, whereby user convenience is further improved.

Moreover, because the vertical wall of the first housing, which is formed between a lowered front upper surface portion and a raised front lower surface portion, has a plane surface contour, one of the corners of the second housing can linearly move while being positioned adjacent to the vertical wall or being brought into sliding contact with the vertical wall. Therefore, when the second housing is placed in the lengthwise direction of the first housing or is rotated through 90° clockwise or counterclockwise with respect to the first housing, one of the side surfaces of the second housing can be kept in close contact with the vertical wall of the first housing. As a consequence, irrespective of the rotation of the second housing, the aesthetic outer appearance of the portable terminal can be maintained and the operating position of the second housing can be stably maintained.

While various examples of forming the first, second and third guide projections 125a, 125b and 125c and defining the corresponding guide grooves have been described above, since the third guide projection 125c and the corresponding guide groove are provided to only stabilize the rotation of the second housing 102 with respect to the first housing 101, they need not be necessarily provided.

When only the first guide projection 125a is formed without the third guide projection 125c, it is to be noted that a projection for supporting the other end of the driving member 103 should be provided on the rear surface of the second housing 102. The projection for supporting the other end of the driving member 103 can be formed at the same position where the second guide projection 125b is formed in the first embodiment.

In the construction of the portable terminal 100 in which the second and third guide projections 125b and 125c are not formed, if the second housing 102 is rotated from the first position to the second or third position, one of the corners of the second housing 102 moves while being brought into sliding contact with the vertical wall of the first housing 101 that defines the lowered front upper surface portion 115. At this time, the second housing 102 is provided with a rotational force applied in a direction for rotating the second housing 102 about a sliding contact point of the second housing 102 on the vertical wall. That is to say, the rotational force is produced due to the positions of the one corner of the second housing 102 and the first guide projection 125a and the driving force from the driving member 103.

The rotational force that is applied to the second housing 102 between the first and second positions acts as driving force for rotating the second housing 102 to the first or second position. Similarly, the rotational force that is applied to the second housing 102 between the first and third positions acts as driving force for rotating the second housing 102 to the first or third position.

In the construction in which only the first and second guide projections 125a and 125b are provided to the portable terminal 100, the third guide groove 117c described in the above embodiments of the present invention need not be necessarily defined, and the other end of the driving member 103 can be supported by the second guide projection 125b.

Although it was described in the above embodiments that one of the corners of the second housing 102 is brought into sliding contact with the vertical wall of the first housing 101 which delimits the lowered front upper surface portion 115, it is to be understood that the one corner of the second housing 102 may not be brought into sliding contact with the vertical wall of the first housing 101 and may linearly move while being positioned adjacent to the vertical wall of the first housing 101. This is made possible when the loci of the second and third guide grooves 117b and 117c are established such that they have the same shapes as those of the first and second embodiments of the present invention and are formed to be further separated from the vertical wall of the first housing 101 than those of the first and second embodiments described herein. Those skilled in the art will readily appreciate that, by changing the positions of the loci of the second and third guide grooves 117b and 117c in this way, the second housing 102 can be rotated while the one corner of the second housing 102 is separated from the vertical wall of the first housing 101 which defines the lowered front upper surface portion 115.

Furthermore, while it was described in the first embodiment of the present invention that the ends of the driving member 103 are supported by the support projection 119 and the second guide projection 125b, respectively, it is contemplated that the driving member 103 can be installed in the first guide groove 117a. In other words, when installing the driving member 103, which comprises a coil type compression spring or a zigzag type wire spring and provides tensile driving force, one end of the driving member 103 can be supported in the upper end of the first guide groove 117a, and the other end of the driving member 103 can be supported by the first guide projection 125a, whereby driving force for rotating the second housing 102 can be provided.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A portable terminal comprising:
a first housing having a lowered surface portion; and
a second housing seated on the lowered surface portion of the first housing to be rotated while facing the first housing,
wherein, when the second housing is placed at a first position that is in a lengthwise direction to the first housing, or at second a or third positions rotated from the first position by 90° to a direction perpendicular to the lengthwise direction, any one of sidewalls of the second housing is held in close contact to a vertical wall of the first housing defined between the lowered surface portion and a raised surface portion of the first housing.

2. The portable terminal according to claim 1, wherein the second housing comprises a display, which is provided on one surface of the second housing, and a pair of speakers, which are arranged adjacent to upper and lower ends, respectively, of the display.

3. The portable terminal according to claim 2, wherein the display selectively provides a wide display window in the lengthwise or the perpendicular direction as the second housing is rotated.

4. The portable terminal according to claim 1, wherein the first housing comprises a keypad, which is provided on one surface of the first housing, and a microphone, which is arranged adjacent to a lower end of the keypad.

5. The portable terminal according to claim 1, wherein the vertical wall of the first housing has a plane surface contour, and, when the second housing is rotated, one of corners of the second housing linearly moves while being positioned adjacent to the vertical wall of the first housing and being in sliding contact therewith.

6. The portable terminal according to claim 1, further comprising:
a driving member interposed between the first and second housings to provide a rotational driving force,
wherein the driving member applies driving force for rotating the second housing toward the first or second position, depending upon a rotated position of the second housing between the first and second positions, or the driving member applies driving force for rotating the second housing toward the first or third position, depending upon a rotated position of the second housing between the first and third positions.

7. The portable terminal according to claim 6, wherein the driving member applies compressive elastic force pulling both ends thereof toward each other, wherein a position where both ends of the driving member are farthest apart from each other exists when the second housing is rotated between the first and second positions or between the first and third positions.

8. The portable terminal according to claim 1, further comprising:
a first guide projection formed on a rear surface of the second housing and linearly movably coupled to the first housing, the first guide projection providing a rotation center of the second housing.

9. The portable terminal according to claim 8, further comprising:
a second guide projection formed on the rear surface of the second housing and spaced apart from the first guide projection to be moved along a curved locus on the first housing when the second housing is rotated.

10. The portable terminal according to claim 9, further comprising:
a driving member interposed between the first and second housings to provide a rotational driving force; and
a support projection formed on the lowered surface portion of the first housing, wherein one end of the driving member is connected to the support projection and the other end of the driving member is connected to the second guide projection.

11. The portable terminal according to claim 9, wherein the lowered surface portion of the first housing has a first guide groove in which the first guide projection is moved, and a second guide groove which is defined along a movement locus of the second guide projection when the second housing is rotated.

12. The portable terminal according to claim 11, wherein the second guide groove is defined at both sides of the first guide groove and is symmetrical with respect to the first guide groove.

13. The portable terminal according to claim 12, wherein the second guide groove extends laterally from both sides of the first guide groove, the first and second guide projections are placed in the first guide groove when the second housing is placed at the first position, and the second guide projection is placed in an end of the second guide groove when the second housing is placed at the second or third position.

14. The portable terminal according to claim 1, further comprising:
a first guide projection formed on a rear surface of the second housing;
a second guide projection formed on the rear surface of the second housing and spaced apart from the first guide projection; and
a third guide projection formed on the rear surface of the second housing and spaced apart from the second guide projection,
wherein the first, second and third guide projections are arranged in a straight line.

15. The portable terminal according to claim 14, further comprising:
a driving member interposed between the first and second housings to provide a rotational driving force; and
a support projection formed on the lowered surface portion of the first housing, wherein one end of the driving member is connected to the support projection and the other end of the driving member is connected to the second guide projection.

16. The portable terminal according to claim 14, wherein the first guide projection is linearly movably coupled to the first housing and provides a rotation center of the second housing, and the second and third guide projections move along different curved loci on the first housing when the second housing is rotated.

17. The portable terminal according to claim 16, wherein the lowered surface portion of the first housing has a first guide groove in which the first guide projection is moved, a second guide groove which is defined along a movement locus of the second guide projection when the second housing is rotated, and a third guide groove which is defined along a movement locus of the third guide projection when the second housing is rotated.

18. The portable terminal according to claim 17, wherein the second guide groove is defined at both sides of the first guide groove and is symmetrical with respect to the first guide groove.

19. The portable terminal according to claim 18, wherein the first, second and third guide projections are arranged in a straight line, the first and second guide projections are placed in the first guide groove when the second housing is placed at the first position, and the second guide projection is placed in an end of the second guide groove and the third guide projection is placed in an end of the third guide groove when the second housing is placed at the second or third position.

20. The portable terminal according to claim 1, further comprising:
a first guide projection formed on a rear surface of the second housing;
a second guide projection formed on the rear surface of the second housing and spaced apart from the first guide projection;
a first guide groove for guiding movement of the first guide projection;
a second guide groove defined along a movement locus of the second guide projection when the second housing is rotated;
a driving member having one end connected to one end of the first guide groove and an other end connected to the first guide projection, and applying tensile driving force for allowing both ends thereof to be pushed away from each other,
wherein the first guide projection is linearly movably coupled to the first housing and provides a rotation center of the second housing, and the second guide projection is moved along the second guide groove when the second housing is rotated.

21. A portable terminal comprising:
a first housing having a lowered surface portion;
a second housing seated on the lowered surface portion of the first housing to be rotated while facing the first housing; and
a driving member interposed between the first and second housings to provide driving force for rotating the second housing,
wherein a vertical wall of the first housing, which is defined between the lowered surface portion and a raised surface portion of the first housing, has a plane surface contour, and, when the second housing is rotated, one of corner of the second housing linearly moves while positioned adjacent to the vertical wall of the first housing or being brought into sliding contact therewith.

22. The portable terminal according to claim 21, wherein the second housing is stopped from being rotated at a first position when placed in a lengthwise direction of the first housing and second and third positions when rotated from the first position by 90° to a direction perpendicular to the lengthwise direction of the first housing, and the driving member provides a driving force for rotating the second housing to the first, second or third position.

23. The portable terminal according to claim 22, wherein the driving member applies compressive elastic force for allowing both ends thereof to be pulled toward each other, a position where both ends of the driving member are farthest apart from each other exists when the second housing is rotated between the first and second positions, and a position where both ends of the driving member are farthest apart from each other exists when the second housing is rotated between the first and third positions.

24. The portable terminal according to claim 21, further comprising:
a first guide projection formed on a rear surface of the second housing and linearly movably coupled to the first housing;
a second guide projection formed on the rear surface of the second housing and spaced apart from the first guide projection; and
a support projection formed on the lowered surface portion of the first housing,
wherein one end of the driving member is connected to the support projection and an other end of the driving member is connected to the second guide projection.

25. The portable terminal according to claim 24, wherein the first guide projection is linearly movably coupled to the first housing and provides a rotation center of the second housing.

26. The portable terminal according to claim 24, wherein the first guide projection is formed on a center portion of the rear surface of the second housing.

27. The portable terminal according to claim 24, further comprising:
a third guide projection formed on the rear surface of the second housing and spaced apart from the first guide projection, wherein the first, second and third guide projections are arranged in a straight line.

28. The portable terminal according to claim 27, wherein the lowered surface portion of the first housing has a first guide groove in which the first guide projection is moved, and a third guide groove which is defined along a movement locus of the third guide projection when the second housing is rotated.

29. The portable terminal according to claim 28,
wherein the second housing is stopped from being rotated at a first position in a lengthwise direction to the first housing or at second and positions rotated from the first position by 90° to a direction perpendicular to the lengthwise direction,
wherein, when the second housing is placed at the first, second or third position, one of sidewall of the second housing is held close to the vertical wall of the first housing, and
wherein, when the second housing is not placed at the first, second or third position and is rotated and the third guide projection is moved along the third guide groove, one corner of the second housing linearly moves while being separated from the vertical wall of the first housing.

30. The portable terminal according to claim 28, wherein the third guide groove extends from a center portion of the lowered surface portion of the first housing in both sideward directions and is left-to-right symmetrical.
